(19) United States
(12) Patent Application Publication
(10) Pub. No.: US 2020/0387922 A1
(43) Pub. Date: Dec. 10, 2020

(54) POINTS MANAGEMENT METHOD AND POINTS MANAGEMENT APPARATUS

(71) Applicant: TOSHIBA TEC KABUSHIKI KAISHA, Tokyo (JP)

(72) Inventors: Yasuhiro KINOSHITA, Tama Tokyo (JP); Yuuichi KOBA, Kawasaki Kanagawa (JP)

(21) Appl. No.: 16/819,965

(22) Filed: Mar. 16, 2020

(30) Foreign Application Priority Data
Jun. 4, 2019 (JP) 2019-104782

(51) Int. Cl. G06Q 30/02; G06F 16/23; G06Q 20/36; G06Q 20/38; G06Q 20/40; G06Q 20/20

(52) U.S. Cl. CPC G06Q 30/0227; G06F 16/2379; G06Q 30/0213; G06Q 20/202; G06Q 20/385; G06Q 20/40145; G06Q 20/3678

(57) ABSTRACT

In accordance with an embodiment, a points management method includes recording, in a distributed ledger, transaction data showing remaining points retained in a points account. The points management method includes determining points of the remaining points on the basis of a function determined on the basis of a combination of a points issue source and a points use destination, the points being usable at the points use destination.

### CROSS-REFERENCE TO RELATED APPLICATION

This application is based upon and claims the benefit of priority from the prior Japanese Patent Application No. 2019-104782, filed on Jun. 4, 2019, the entire contents of which are incorporated herein by reference.

### FIELD

An embodiment described here generally relates to a points management method and a points management apparatus.

### BACKGROUND

Conventionally, sharing (commonizing) by which the corporate currency (points) is usable between different issuers has been performed. For example, a common database or the like is provided between a plurality of issuers and the points issued by each points issuer are summed as common points in a common database, such that the points are shared. Alternatively, the database of each points issuer converts points managed on each database to other points, such that the points are shared.

By the way, managing points by using a distributed ledger of a blockchain or the like has been proposed. However, in the case of managing points by using the distributed ledger, a system of sharing the points does not exist.

### BRIEF DESCRIPTION OF THE DRAWINGS

FIG. 1 is a block diagram showing an example of a configuration of a points system (reward system) according to an embodiment.

FIG. 2 is a block diagram showing an example of a main-part circuit configuration of a node of the points system according to the embodiment.

FIG. 3 is a block diagram showing an example of a main-part circuit configuration of a headquarter server of the points system according to the embodiment.

FIG. 4 is a block diagram showing an example of a main-part circuit configuration of a store server of the points system according to the embodiment.

FIG. 5 is a block diagram showing an example of a main-part circuit configuration of a POS terminal of the points system according to the embodiment.

FIG. 6 is a block diagram showing an example of a main-part circuit configuration of a client terminal of the points system according to the embodiment.

FIG. 7 is a flowchart showing an example of the processing of a processor the POS terminal according to the embodiment.

FIG. 8 is a diagram showing an example of a table stored in an auxiliary storage device according to the embodiment.

FIG. 9 is a diagram showing an example of an image displayed by a display device according to the embodiment.

FIG. 10 is a flowchart showing an example of the processing of the processor of the POS terminal according to the embodiment.

FIG. 11 is a flowchart showing the example of the processing of the processor of the POS terminal according to the embodiment.

FIG. 12 is a flowchart showing an example of processing of a processor of the client terminal according to the embodiment.

### DETAILED DESCRIPTION

In accordance with one embodiment, a points management method is for commonly managing points by using a distributed ledger, the points being issued to a customer in a manner that depends on purchase of a commodity or use of a service from a plurality of different points issue sources and being usable by the customer for at least a part of a price of purchase of a commodity or use of a service at a plurality of points use destinations. The points management method includes recording, in the distributed ledger, transaction data showing remaining points retained in a points account of each customer, the points account being used as a wallet. The points management method includes determining a points account of a customer by using an identification code uniquely given to each points account. The points management method includes determining remaining points retained in the determined points account on the basis of the transaction data. The points management method includes determining points of the determined remaining points on the basis of a function determined on the basis of a combination of one of the plurality of different points issue sources and one of the plurality of points use destinations, the points being usable at the one of the plurality of points use destinations.

A points system (reward system) according to an embodiment will be described with reference to the drawings. It should be noted that a configuration(s) will be omitted from some of the drawings, which will be referred to for describing the following embodiment, for the sake of description. In the drawings and the following descriptions, identical symbols denote identical or similar parts.

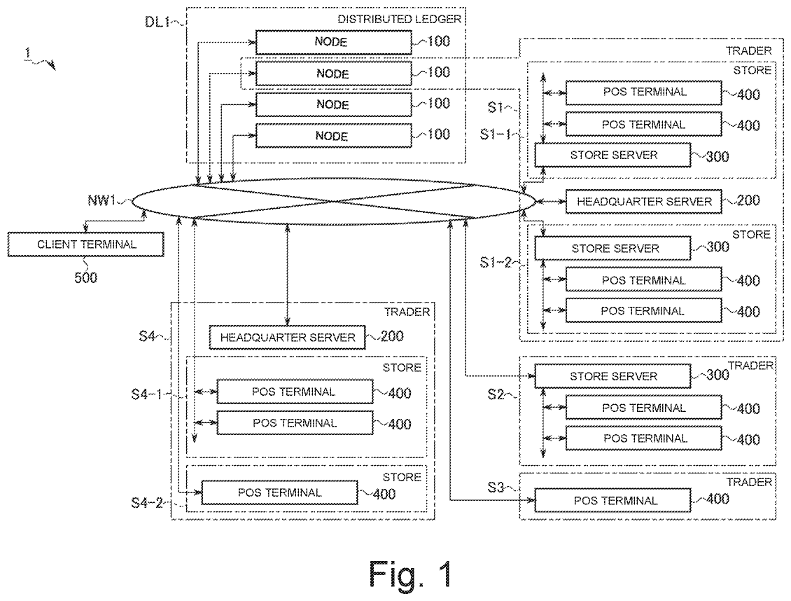

FIG. 1 is a block diagram showing an example of a configuration of a points system 1 according to the embodiment. The points system 1 manages the corporate currency (points) by using a distributed ledger DL1. Further, the points system 1 shares different points from different issuers (issue sources) and makes those different points usable. It should be noted that the points managed by the points system 1 are issued to a customer (shopping client) in a manner that depends on the purchase of the commodity or the use of the service and are usable by the shopping client at a plurality of points use destinations as at least a part of the price of the purchase of the commodity or the use of the service. For example, the points are calculated and given under a certain condition to a shopping client or the like who has purchased a commodity, service, or the like. That is, the points managed by the points system 1 are points to be used in a loyalty program. It should be noted that the distributed ledger DL1 manages issue of points and a condition for using points through a smart contract, for example. The points system 1 includes nodes 100, a headquarter server 200, store servers 300, points of sales (POS) terminals 400, and a client terminal 500, for example. It should be noted that regarding the nodes 100, the headquarter server 200, the store servers 300, the POS terminals 400, and the client terminal 500 shown in FIG. 1, those components shall not be construed as being limitative and a larger or smaller number of those components can be provided.

The node 100 is a personal computer (PC), a server apparatus, or the like to be connected to a network NW1. The network NW1 is typically a communication network including the Internet. The nodes 100 are nodes that join the distributed ledger DL1. The multiple nodes 100 construct a peer-to-peer (P2P) network in the network NW1. The distributed ledger DL1 operates via the P2P network. The distributed ledger DL1 is, for example, a blockchain or another type of distributed ledger.

The headquarter server 200, the store servers 300, and the POS terminals 400 are installed in headquarters, stores, or the like of traders that sell commodities, services, or the like in order to perform sale, management, and the like of commodities. The headquarter server 200, the store servers 300, and the POS terminals 400 are apparatuses that belong to a POS system, for example. The POS terminal 400 is an example of a points management apparatus. The headquarter server 200 is installed in the headquarter or the like of the trader, for example. The headquarter server 200 receives sale information or the like sent from the store servers 300 installed at a plurality of stores, for example.

Then, the headquarter server 200 stores and manages the sale information or the like. The store server 300 is installed at each store, for example. The store server 300 receives the sale information or the like sent from the POS terminals 400 installed at the store. Then, the store server 300 receives the sale information or the like sent from the POS terminals 400 installed at the store and manages the sale information or the like of that store.

The POS terminals 400 are installed on register tables or the like in each store. The POS terminals 400 are register work terminals that perform registration of commodities that are settlement targets, settlement with respect to the registered commodities, and the like. The POS terminals 400 are operated by an employee of the store or the like, for example. Alternatively, the POS terminals 400 may be self-type terminals to be operated by a shopping client of the store or the like. Further, the POS terminal 400 may be a semi-self-type apparatus including a registration device that performs registration of commodities and a settlement device that performs settlement with respect to the registered commodities. The semi-self-type registration device is operated by an employee of the store or the like, for example. The semi-self-type settlement device is operated by a shopping client of the store or the like, for example.

The headquarter server 200, the store servers 300, and the POS terminals 400 are different in form of installation between traders. FIG. 1 shows traders S1 to S4 as an example of the traders.

The trader S1 includes a plurality of stores, for example. The trader S1 installs the headquarter server 200 at the headquarter. That headquarter server 200 connects to the network NW1. The trader S1 includes a plurality of stores such as a store S1-1 and a the store S1-2. The store servers 300 and the plurality of POS terminals 400 are installed in the store S1-1 and the store S1-2. Those store servers 300 connect to the network NW1. Further, the store server 300 connects the POS terminals 400 in the same store. Further, the trader S1 installs the nodes 100. It should be noted that only the trader S1 installs the nodes 100 in FIG. 1. However, each of the other traders may also install the nodes 100.

The trader S2 is, for example, a single store. The trader S2 does not install the headquarter server 200 because the trader S2 is the single store, for example. The trader S2 installs the store server 300 and the plurality of POS terminals 400. That store server 300 connects to the network NW1. The store server 300 connects to the POS terminals 400 in the trader S2.

The trader S3 is, for example, a single store. The trader S3 does not install the headquarter server 200 and the store server 300. The trader S3 installs only the POS terminal 400. That POS terminal 400 connects to the network NW1. In the trader S3, the POS terminal 400 manages and stores sale information or the like, for example.

The trader S4 installs the headquarter server 200. That headquarter server 200 connects to the network NW1. The trader S4 includes a plurality of stores such as a store S4-1 and a store S4-2. One or more POS terminals 400 are installed in each of the store S4-1 and the store S4-2. The store server 300 is not installed in each of the store S4-1 and the store S4-2. In the trader S4, the POS terminals 400 directly send sale information or the like to the headquarter server 200.

It should be noted that at least any one of the headquarter server 200, the store servers 300, and the POS terminals 400 installed by the trader stores a trader identifier (ID) of the above-mentioned trader. The trader ID is an identification code uniquely given to each trader.

The client terminal 500 is a terminal apparatus to be operated by the shopping client or the like. The client terminal 500 is used by the shopping client or the like for checking the remaining points or the like. The client terminal 500 is an information terminal such as a smartphone to be used by the shopping client, for example. Alternatively, the client terminal 500 is an apparatus or the like that is installed in the store or the like and displays various types of information based on an operation made by the shopping client. The client terminal 500 is an example of the points management apparatus.

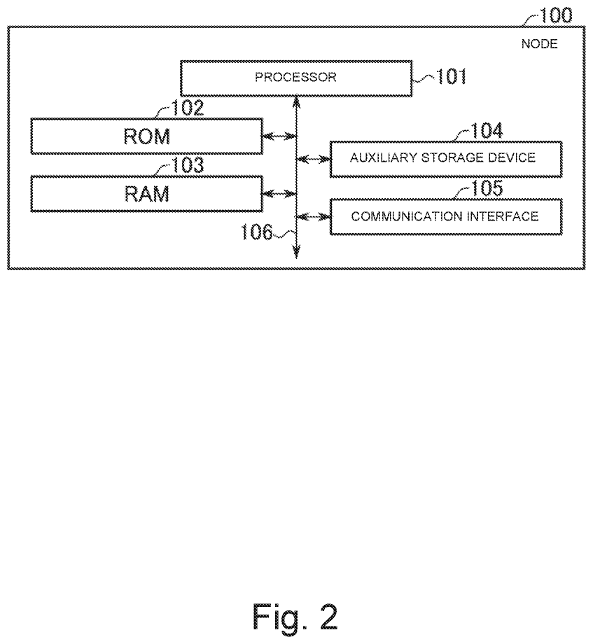

Next, a configuration of each of the nodes 100, the headquarter server 200, the store servers 300, the POS terminals 400, and the client terminal 500 will be described with reference to FIGS. 2 to 6.

FIG. 2 is a block diagram showing an example of a main-part circuit configuration of the node 100. The node 100 includes, for example, a processor 101, a read-only memory (ROM) 102, a random-access memory (RAM) 103, an auxiliary storage device 104, and a communication interface 105. Then, a bus 106 or the like connects those respective blocks 101 to 105.

The processor 101 corresponds to a central part of a computer that performs processing of arithmetic operation, control, and the like necessary for operation of the node 100. The processor 101 controls the respective blocks in order to realize various functions of the node 100 on the basis of programs such as firmware, system software, and application software stored in the ROM 102, the auxiliary storage device 104, or the like. It should be noted that some or all of those programs may be incorporated in the circuit of the processor 101. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA), or the like. Alternatively, the processor 101 is constituted by two or more of those devices.

The ROM 102 corresponds to a main storage unit of the computer having the processor 101 as the center. The ROM 102 is a nonvolatile memory mainly used for reading data. The ROM 102 stores, for example, the firmware or the like of the above-mentioned programs. Further, the ROM 102 stores data, various setting values, and the like to be used by the processor 101 for performing various types of processing.

The RAM 103 corresponds to a main storage unit of the computer having the processor 101 as the center. The RAM 103 is a memory to be used for reading and writing data. The RAM 103 is used as a so-called work area or the like for storing data to be temporarily used by the processor 101 for performing various types of processing. The RAM 103 is typically a volatile memory.

The auxiliary storage device 104 corresponds to an auxiliary storage unit of the computer having the processor 101 as the center. The auxiliary storage device 104 is an electric erasable programmable read-only memory (EEPROM), a hard disk drive (HDD), a flash memory, or the like, for example. The auxiliary storage device 104 stores, for example, the system software, the application software, and the like of the above-mentioned programs. Further, the auxiliary storage device 104 stores data to be used by the processor 101 for performing various types of processing, data generated by the processing of the processor 101, various setting values, and the like.

The programs stored in the ROM 102 or the auxiliary storage device 104 include a program for executing processing to be described later. For example, the node 100 is transferred to the administrator or the like of the node 100 in a state in which such a program is not stored in the ROM 102 or the auxiliary storage device 104. Then, the program separately transferred to the administrator or the like is written in the auxiliary storage device 104 in accordance with an operation made by the administrator or the like. However, the node 100 may be transferred to the administrator or the like in a state in which such a program is stored in the ROM 102 or the auxiliary storage device 104. The transfer of the program can be realized by recording the program in a removable storage medium such as a magnetic disk, a magneto-optical disk, an optical disc, and a semiconductor memory, for example, or by downloading the program via the network NW1 or the like.

The communication interface 105 is an interface for the node 100 to perform communication via the network NW1 or the like.

The bus 106 includes a control bus, an address bus, a data bus, and the like and transmits signals exchanged between the respective blocks of the node 100.

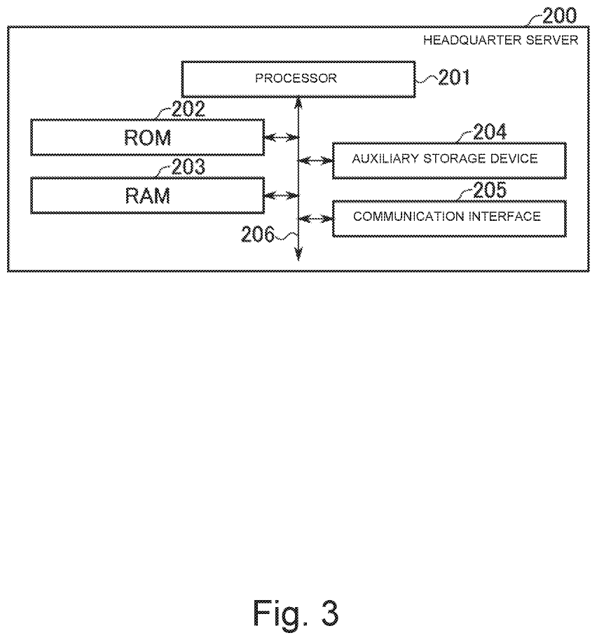

FIG. 3 is a block diagram showing an example of a main-part circuit configuration of the headquarter server 200. The headquarter server 200 includes a processor 201, a ROM 202, a RAM 203, an auxiliary storage device 204, and a communication interface 205, for example. Then, a bus 206 or the like connects those respective blocks 201 to 205.

The processor 201 corresponds to a central part of a computer that performs processing of arithmetic operation, control, and the like necessary for operation of the headquarter server 200. The processor 201 controls the respective blocks in order to realize various functions of the headquarter server 200 on the basis of programs such as firmware, system software, and application software stored in the ROM 202, the auxiliary storage device 204, or the like. It should be noted that some or all of those programs may be incorporated in the circuit of the processor 201. The processor 201 is a CPU, a MPU, a SoC, a DSP, a GPU, an ASIC, a PLD, a FPGA, or the like, for example. Alternatively, the processor 201 is constituted by two or more of those devices.

The ROM 202 corresponds to a main storage unit of the computer having the processor 201 as the center. The ROM 202 is a nonvolatile memory mainly used for reading data. The ROM 202 stores, for example, the firmware or the like of the above-mentioned programs. Further, the ROM 202 stores data, various setting values, and the like to be used by the processor 201 for performing various types of processing.

The RAM 203 corresponds to a main storage unit of the computer having the processor 201 as the center. The RAM 203 is a memory to be used for reading and writing data. The RAM 203 is used as a so-called work area or the like for storing data to be temporarily used by the processor 201 for performing various types of processing. The RAM 203 is typically a volatile memory.

The auxiliary storage device 204 corresponds to an auxiliary storage unit of the computer having the processor 201 as the center. The auxiliary storage device 204 is an EEPROM, an HDD, a flash memory, or the like, for example. The auxiliary storage device 204 stores, for example, the system software, the application software, and the like of the above-mentioned programs. Further, the auxiliary storage device 204 stores data to be used by the processor 201 for performing various types of processing, data generated by the processing of the processor 201, various setting values, and the like.

The programs stored in ROM 202 or the auxiliary storage device 204 include a program for executing processing to be described later. for example, the headquarter server 200 is transferred to the administrator or the like of the headquarter server 200 in a state in which such a program is not stored in the ROM 202 or the auxiliary storage device 204. Then, the program separately transferred to the administrator or the like is written in the auxiliary storage device 204 in accordance with an operation made by the administrator or the like. However, the headquarter server 200 may be transferred to the administrator or the like in a state in which such a program is stored in the ROM 202 or the auxiliary storage device 204. The transfer of the program can be realized by recording the program in a removable storage medium such as a magnetic disk, a magneto-optical disk, an optical disc, and a semiconductor memory, for example, or by downloading the program via the network NW1 or the like.

The communication interface 205 is an interface for the headquarter server 200 to perform communication via the network NW1 or the like.

The bus 206 includes a control bus, an address bus, a data bus, and the like and transmits signals exchanged between the respective blocks of the headquarter server 200.

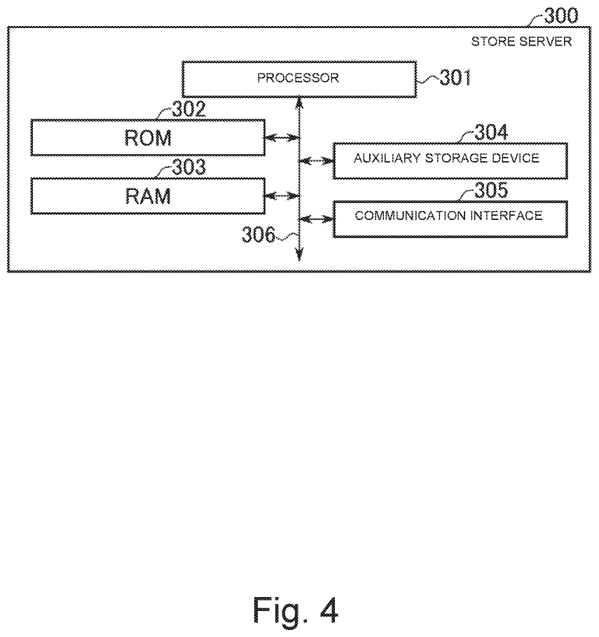

FIG. 4 is a block diagram showing an example of a main-part circuit configuration of the store server 300. The store server 300 includes a processor 301, a ROM 302, a RAM 303, an auxiliary storage device 304, and a communication interface 305, for example. Then, the bus 306 or the like connects those respective blocks 301 to 305.

The processor 301 corresponds to a central part of a computer that performs processing of arithmetic operation, control, and the like necessary for operation of the store server 300. The processor 301 controls the respective blocks in order to realize various functions of the store server 300 on the basis of programs such as firmware, system software, and application software stored in the ROM 302, the auxiliary storage device 304, or the like. It should be noted that some or all of those programs may be incorporated in the circuit of the processor 301. The processor 301 is a CPU, a MPU, a SoC, a DSP, a GPU, an ASIC, a PLD, a FPGA, or the like, for example. Alternatively, the processor 301 is constituted by two or more of those devices.

The ROM 302 corresponds to a main storage unit of the computer having the processor 301 as the center. The ROM 302 is a nonvolatile memory mainly used for reading data. The ROM 302 stores, for example, the firmware or the like of the above-mentioned programs. Further, the ROM 302 stores data, various setting values, and the like to be used by the processor 301 for performing various types of processing.

The RAM 303 corresponds to a main storage unit of the computer having the processor 301 as the center. The RAM 303 is a memory to be used for reading and writing data. The RAM 303 is used as a so-called work area or the like for storing data to be temporarily used by the processor 301 for performing various types of processing. The RAM 303 is typically a volatile memory.

The auxiliary storage device 304 corresponds to an auxiliary storage unit of the computer having the processor 301 as the center. The auxiliary storage device 304 is an EEPROM, an HDD, a flash memory, or the like, for example. The auxiliary storage device 304 stores, for example, the system software, the application software, and the like of the above-mentioned programs. Further, the auxiliary storage device 304 stores data to be used by the processor 301 for performing various types of processing, data generated by the processing of the processor 301, various setting values, and the like.

The programs stored in ROM 302 or the auxiliary storage device 304 include a program for executing processing to be described later. For example, the store server 300 is transferred to the administrator or the like of the store server 300 in a state in which such a program is not stored in the ROM 302 or the auxiliary storage device 304. Then, the program separately transferred to the administrator or the like is written in the auxiliary storage device 304 in accordance with an operation made by the administrator or the like. However, the store server 300 may be transferred to the administrator or the like in a state in which such a program is stored in the ROM 302 or the auxiliary storage device 304. The transfer of the program can be realized by recording the program in a removable storage medium such as a magnetic disk, a magneto-optical disk, an optical disc, and a semiconductor memory, for example, or by downloading the program via the network NW1 or the like.

The communication interface 305 is an interface for the store server 300 to perform communication via the network NW1 or the like. Further, the communication interface 305 is an interface for the store server 300 to perform communication with the POS terminals 400 or the like.

The bus 306 includes a control bus, an address bus, a data bus, and the like and transmits signals exchanged between the respective blocks of the store server 300.

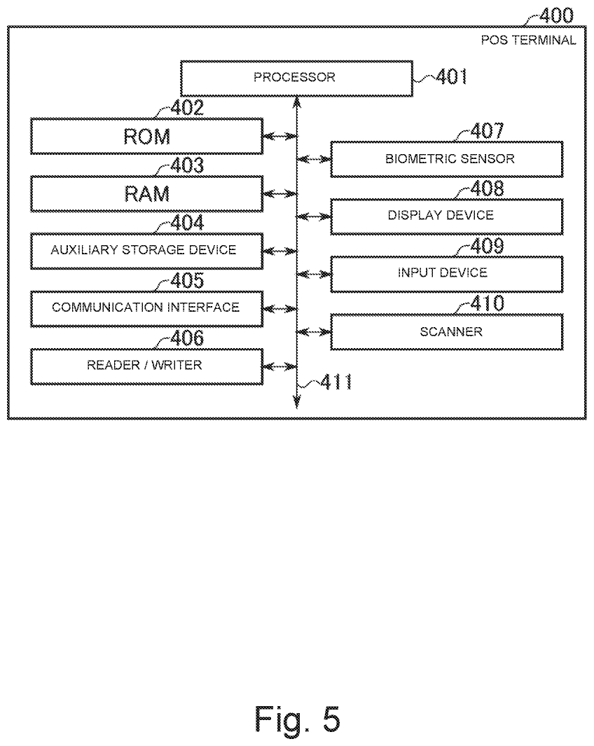

FIG. 5 is a block diagram showing an example of a main-part circuit configuration of the POS terminal 400. The POS terminal 400 includes a processor 401, a ROM 402, a RAM 403, an auxiliary storage device 404, a communication interface 405, a reader/writer 406, a biometric sensor 407, a display device 408, an input device 409, and a scanner 410, for example. Then, the bus 411 or the like connects those respective blocks.

The processor 401 corresponds to a central part of a computer that performs processing of arithmetic operation, control, and the like necessary for operation of the POS terminal 400. The processor 401 controls the respective blocks in order to realize various functions of the POS terminal 400 on the basis of programs such as firmware, system software, and application software stored in the ROM 402, the auxiliary storage device 404, or the like. It should be noted that some or all of those programs may be incorporated in the circuit of the processor 401. The processor 401 is a CPU, a MPU, a SoC, a DSP, a GPU, an ASIC, a PLD, a FPGA, or the like, for example. Alternatively, the processor 401 is constituted by two or more of those devices.

The ROM 402 corresponds to a main storage unit of the computer having the processor 401 as the center. The ROM 402 is a nonvolatile memory mainly used for reading data. The ROM 402 stores, for example, the firmware or the like of the above-mentioned programs. Further, the ROM 402 stores data, various setting values, and the like to be used by the processor 401 for performing various types of processing.

The RAM 403 corresponds to a main storage unit of the computer having the processor 401 as the center. The RAM 403 is a memory to be used for reading and writing data. The RAM 403 is used as a so-called work area or the like for storing data to be temporarily used by the processor 401 for performing various types of processing. The RAM 403 is typically a volatile memory.

The auxiliary storage device 404 corresponds to an auxiliary storage unit of the computer having the processor 401 as the center. The auxiliary storage device 404 is an EEPROM, an HDD, a flash memory, or the like, for example. The auxiliary storage device 404 stores, for example, the system software, the application software, and the like of the above-mentioned programs. Further, the auxiliary storage device 404 stores data to be used by the processor 401 for performing various types of processing, data generated by the processing of the processor 401, various setting values, and the like. Further, the auxiliary storage device 404 stores a commodity list that is a list of commodities and services registered as purchase targets. Alternatively, the RAM 403 may store such a commodity list. In addition, the auxiliary storage device 404 also stores a commodity database including various types of information regarding commodity codes, commodity names, amounts regarding commodities sold in the store, and the like.

The programs stored in the ROM 402 or the auxiliary storage device 404 include a program for executing processing to be described later. For example, the POS terminal 400 is transferred to the administrator or the like of the POS terminal 400 in a state in which such a program is stored in the ROM 402 or the auxiliary storage device 404. However, the POS terminal 400 may be transferred to the administrator or the like in a state in which the program is not stored in the ROM 402 or the auxiliary storage device 404. Further, the POS terminal 400 may be transferred to the administrator or the like in a state in which a program other than such a program is stored in the ROM 402 or the auxiliary storage device 404. Then, a program for executing processing to be described later may be separately transferred to the administrator or the like and may be written in the ROM 402 or the auxiliary storage device 404 in accordance with an operation made by the administrator or a serviceman or the like. The transfer of the program at this time can be realized by recording the program in a removable storage medium such as a magnetic disk, a magneto-optical disk, an optical disc, and a semiconductor memory, for example, or by downloading the program via the network NW1 or the like.

The communication interface 405 is an interface for the POS terminal 400 to communicate with the store servers 300 or the like. Further, the communication interface 405 is an interface for the POS terminal 400 to perform communication via the network NW1 or the like.

The reader/writer 406 communicates with a magnetic card (magnetic stripe card), a contact-type IC card, a contactless type IC card, or the like. Accordingly, the reader/writer 406 reads information stored in a points card. Further, the reader/writer 406 writes information on the points card. Further, the points card is not limited to the card-like form. For example, the reader/writer 406 communicates with a contactless IC chip as a storage unit installed in an electronic apparatus (e.g., a portable phone, a smartphone, a tablet PC, or the like). Accordingly, the reader/writer 406 reads information stored in the storage unit of the electronic apparatus having a function of the points card. Further, the reader/writer 406 writes information in the storage unit of the electronic apparatus. The reader/writer 406 may be peripheral equipment or the like externally attached to the POS terminal 400 or may be integral with the POS terminal 400.

It should be noted that the points card stores a points ID, for example. The points ID is an identification code uniquely given to each points account, for example. The points account is a wallet for points to be used in the distributed ledger DL1, for example. The points ID is a wallet address or the like, for example.

The biometric sensor 407 is a sensor or the like that reads, from a person such as the shopping client or the like, biometric information of a physical feature of the face, the fingerprint, the iris, or the like, a behavior feature, or the like in order to perform biometrics authentication. It should be noted that the biometric sensor 407 may be peripheral equipment or the like externally attached to the POS terminal 400 or may be integral with the POS terminal 400. The biometric sensor 407 is a fingerprint sensor, a camera, or the like, for example.

The display device 408 displays a screen for notifying an operator of the POS terminal 400 of various types of information. The display device 408 is a display such as a liquid-crystal display and an organic electro-luminescence (EL) display, for example.

The input device 409 receives an operation made by the operator of the POS terminal 400. The input device 409 is a keyboard, a key pad, a touch pad, a mouse, or the like, for example. Further, touch panels may be used for the display device 408 and the input device 409. That is, a display panel provided in a touch panel may be used as the display device 408. Then, a pointing device according to a touch input, which is provided in a touch panel, may be used as the input device 409.

The scanner 410 reads a barcode or two-dimensional code displayed on a commodity or the like and outputs the commodity code or the like indicated by this barcode or two-dimensional code. The scanner 410 may be a type used by holding it by hand or may be a type fixed on a register table or the like. Further, the scanner 410 may be peripheral equipment or the like externally attached to the POS terminal 400 or may be integral with the POS terminal 400.

It should be noted that the points card may include a barcode or two-dimensional code or the like for storing the user ID. Further, the points card is not limited to the card-like form and the points card may be display the barcode or two-dimensional code or the like on a screen of an electronic apparatus such as a smartphone or the like. The barcode or two-dimensional code stores the user ID or the like. The user ID may be an identification code assigned to each electronic apparatus or each application software module. The scanner 410 reads that barcode or two-dimensional code and outputs the points ID indicated by the barcode or two-dimensional code or the like.

The bus 411 includes a control bus, an address bus, a data bus, and the like and transmits signals exchanged between the respective blocks of the POS terminal 400.

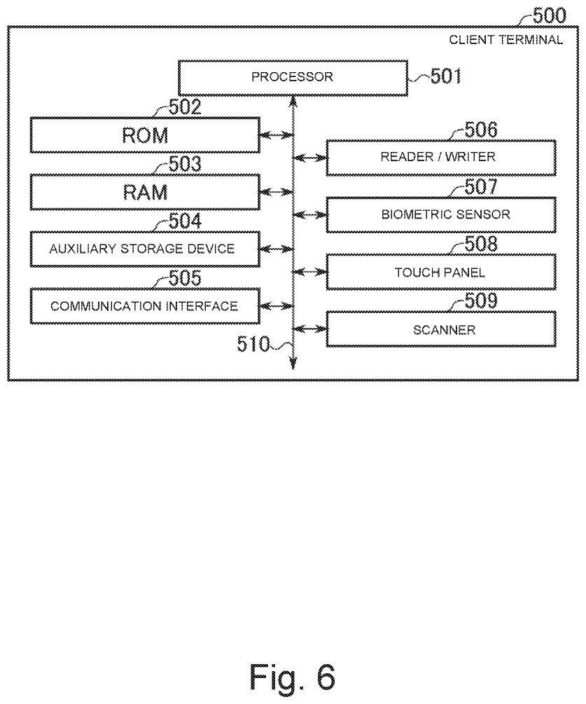

FIG. 6 is a block diagram showing an example of a main-part circuit configuration of the client terminal 500. The client terminal 500 includes a processor 501, a ROM 502, a RAM 503, an auxiliary storage device 504, a communication interface 505, a reader/writer 506, a biometric sensor 507, a touch panel 508, and a scanner 509, for example. Then, a bus 510 or the like connects those respective blocks.

The processor 501 corresponds to a central part of a computer that performs processing of arithmetic operation, control, and the like necessary for operation of the client terminal 500. The processor 501 controls the respective blocks in order to realize various functions of the client terminal 500 on the basis of programs such as firmware stored in the ROM 502, the auxiliary storage device 504, or the like, system software, and application software. It should be noted that some or all of those programs may be incorporated in the circuit of the processor 501. The processor 501 is a CPU, a MPU, a SoC, a DSP, a GPU, an ASIC, a PLD, a FPGA, or the like, for example. Alternatively, the processor 501 is constituted by two or more of those devices.

The ROM 502 corresponds to a main storage unit of the computer having the processor 501 as the center. The ROM 502 is a nonvolatile memory mainly used for reading data. The ROM 502 stores, for example, the firmware or the like of the above-mentioned programs. Further, the ROM 502 stores data, various setting values, and the like to be used by the processor 501 for performing various types of processing.

The RAM 503 corresponds to a main storage unit of the computer having the processor 501 as the center. The RAM 503 is a memory to be used for reading and writing data. The RAM 503 is used as a so-called work area or the like for storing data to be temporarily used by the processor 501 for performing various types of processing. The RAM 503 is typically a volatile memory.

The auxiliary storage device 504 corresponds to an auxiliary storage unit of the computer having the processor 501 as the center. The auxiliary storage device 504 is an EEPROM, an HDD, a flash memory, or the like, for example. The auxiliary storage device 504 stores, for example, the system software, the application software, and the like of the above-mentioned programs. Further, the auxiliary storage device 504 stores data to be used by the processor 501 for performing various types of processing, data generated by the processing of the processor 501, various setting values, and the like.

The programs stored in ROM 502 or the auxiliary storage device 504 include a program for executing processing to be described later. for example, the client terminal 500 is transferred to the administrator or the like of the client terminal 500 in a state in which such a program is not stored in the ROM 502 or the auxiliary storage device 504. Then, the program separately transferred to the administrator or the like is written in the auxiliary storage device 504 in accordance with an operation made by the administrator or the like. However, the client terminal 500 may be transferred to the administrator or the like in a state in which such a program is stored in the ROM 502 or the auxiliary storage device 504. The transfer of the program can be realized by recording the program in a removable storage medium such as a magnetic disk, a magneto-optical disk, an optical disc, and a semiconductor memory, for example, or by downloading the program via the network NW1 or the like.

The communication interface 505 is an interface for the client terminal 500 to perform communication via the network NW1 or the like.

The reader/writer 506 communicates with a magnetic card (magnetic stripe card), a contact-type IC card, a contactless type IC card, or the like. Further, the reader/writer 506 communicates with a contactless IC chip installed in the electronic apparatus (e.g., a portable phone, a smartphone, a tablet PC, or the like).

The biometric sensor 507 is a sensor or the like that reads, from a person such as the shopping client or the like, biometric information of a physical feature of the fingerprint, the iris, the face, or the like, a behavior feature, or the like in order to perform biometrics authentication. The biometric sensor 507 is a fingerprint sensor, a camera, or the like, for example.

The touch panel 508 is obtained by stacking a display such as a liquid-crystal display and an organic EL display and a pointing device according to a touch input, for example. The display of the touch panel 508 functions as a display device that displays a screen for notifying an operator of the client terminal 500 of various types of information. Further, the touch panel 508 functions as an input device that receives a touch operation made by the operator.

The scanner 509 reads the barcode or two-dimensional code or the like and outputs information indicated by this barcode or two-dimensional code or the like. It should be noted that the biometric sensor 507 and the scanner 509 may be a common camera.

The bus 510 includes a control bus, an address bus, a data bus, and the like and transmits signals exchanged between the respective blocks of the client terminal 500.

Hereinafter, an operation of the points system according to the embodiment 1 will be described on the basis of the figures. It should be noted that the contents of the processing in the operation description to be shown below are exemplary and various types of processing that can provide a similar result can be used as appropriate.

Hereinafter, the description will be given by using the yen as an example of the legal tender, though the points system 1 may use the legal tender other than yen, such as the United States dollar or euro. Further, it is assumed that the rate of the corporate currency (points) to the legal tender (yen) is 1 [points]=1 yen for the sake of simplicity in the following description. It should be noted that in a case of the points with brackets as [points], it means the unit.

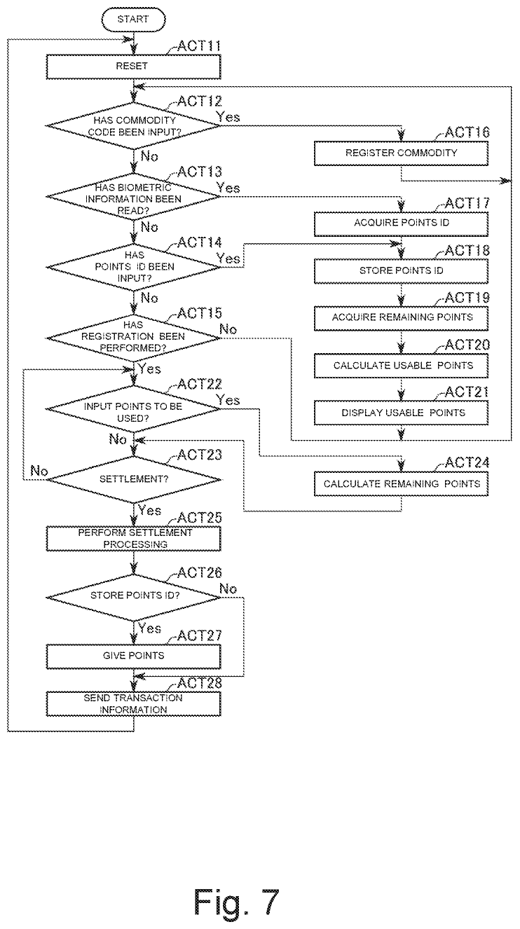

Processing of the POS terminals 400 will be described with reference to FIG. 7. FIG. 7 is a flowchart showing an example of the processing of the processor 401 of the POS terminal 400. The processor 401 executes this processing on the basis of the program stored in the ROM 402 or the auxiliary storage device 404 or the like, for example. It should be noted that in a case where the processing of the processor 401 proceeds to ACT(n+1) after processing of ACTn (n is a natural number), the description about this will be omitted in some cases.

The processor 401 starts the processing shown in FIG. 7 in response to activation of the POS terminal 400, for example. It should be noted that the processor 401 assigns a variable VP1 to the RAM 403 or the like when the processor 401 starts the processing shown in FIG. 7. The variable VP1 is a variable for storing the points ID. In ACT11 of FIG. 7, the processor 401 of the POS terminal 400 resets the commodity list. That is, the processor 401 puts the commodity list stored in the RAM 403 or the auxiliary storage device 404 in a state in which no commodities have been registered. Further, the processor 401 resets the variable VP1 assigned to the RAM 403 and puts a state in which the points ID is not stored as the variable VP1.

In ACT12, the processor 401 determines whether or not the commodity code has been input through the scanner 410. For example, the operator of the POS terminal 400 causes the scanner 410 to read the barcode added to the commodity. When the commodity code recorded in such a barcode is read by the scanner 410, the commodity code output by the scanner 410 is input into the processor 401. It should be noted that the commodity code may be input into the processor by another well-known method. In a case where the processor 401 determines that the commodity code has not been input (No in ACT12), the processing of the processor 401 proceeds to ACT13.

In ACT13, the processor 401 determines whether or not the biometric information has been read through the biometric sensor 407. In a case where the processor 401 determines that the biometric information has not been read through the biometric sensor 407 (No in ACT13), the processing of the processor 401 proceeds to ACT14.

In ACT14, the processor 401 determines whether or not the points ID has been input. For example, when the reader/writer 406 or through the scanner 410 reads the points ID from the points card, the points ID output by the reader/writer 406 or the scanner 410 is input into the processor 401. In a case where the processor 401 determines that the points ID has not been input (No in ACT14), the processing of the processor 401 proceeds to ACT15.

In ACT15, the processor 401 determines whether or not the complete operation to complete registration of commodities has been performed. That is, the processor 401 determines whether or not a prescribed operation, for example, operating a subtotal button of the input device 409 has been performed. It should be noted that an operation of the processor 401 in a case where the complete operation has been performed in a state in which no commodities have been registered in the commodity list may be prescribed by a designer of a program of the processor 401. For example, the processor 401 ignores the complete operation. Alternatively, the processor 401 may be disabled to perform the complete operation itself in a state in which no commodities have been registered. In a case where the processor 401 determines that the complete operation has not been performed (No in ACT15), the processing of the processor 401 returns to ACT12. In this manner, the processor 401 repeats the processing of ACT12 to ACT15 until the processor 401 determines that the commodity code has been input (Yes in ACT12), determines that the biometric information has been read (Yes in ACT13), determines that the points ID has been input determines that (Yes in ACT14), or determines that the complete operation has been performed (Yes in ACT15).

The shopping client brings a commodity that the shopping client wishes to purchase to the POS terminal 400, for example. Then, the operator of the POS terminal 400 inputs the commodity code of the commodity into the POS terminal 400 by reading the barcode added to the commodity through the scanner 410, for example. In a case where the processor 401 determines in ACT12 that the commodity code has been input under the standby state of ACT12 to ACT15 (Yes in ACT12), the processing of the processor 401 proceeds to ACT16.

In ACT16, the processor 401 adds the commodity code input in ACT15 to the commodity list stored in the RAM 403, the auxiliary storage device 404, or the like. The processing of processor 401 returns to ACT12 after the processing of ACT16.

In a case where the processor 401 determines that the biometric information has been read under the standby state of ACT12 to ACT15, in ACT13, through the biometric sensor 407 (Yes in ACT13), the processing of the processor 401 proceeds to ACT17.

In ACT17, the processor 401 acquires a points ID by referring to a biometric information database in which pieces of biometric information are associated with points IDs on the basis of the biometric information read in ACT13. It should be noted that the biometric information database is stored in the auxiliary storage device 204 of the headquarter server 200, the auxiliary storage device 304 of the store server 300, the auxiliary storage device 404 of the POS terminal 400, a server common between the plurality of traders, the distributed ledger DL1, a P2P distributed storage, or the like, for example. The processor 401 acquires the biometric information database from any one of the above-mentioned locations and refers to the acquired biometric information database.

The processing of processor 401 proceeds to ACT18 after the processing of ACT17. Further, in a case where the processor 401 determines in ACT12 that the points ID has been input under the standby state of ACT12 to ACT15 (Yes in ACT14), the processing of the processor 401 proceeds to ACT18.

In ACT18, the processor 401 stores the points ID acquired in ACT17 or the points ID input in ACT14. That is, the processor 401 substitutes the points ID acquired in ACT17 or the points ID input in ACT14 for the variable VP1. It should be noted that the points ID stored as the variable VP1 will be referred to as a “target points ID” hereinafter.

In ACT19, the processor 401 acquires, from the distributed ledger DL1, the remaining points retained in the points account (hereinafter, referred to as a “target points account”) determined on the basis of the target points ID in the following manner, for example. The processor 401 acquires a transaction (transaction information) recorded in the distributed ledger DL1. Then, the processor 401 extracts only a transaction history, which is associated with the target points account, from transaction histories of the points recorded in the transaction. In addition, the processor 401 determines the remaining points of the target points account from the extracted transaction history by calculation. In this manner, the processor 401 acquires the remaining points. It should be noted that the target points account retains points issued by each issue source. The processor 401 determines the remaining points of the target points account for each points issue source. For example, the processor 401 determines the remaining points for each issue source. For example, the processor 401 determines the remaining points whose issue source is the trader S1 as P1 [points], the remaining points whose issue source is the trader S2 as P2 [points], the remaining points whose issue source is the trader S3 as P3 [points], and so on. As described above, the transaction is an example of the transaction data showing remaining points. Therefore, the processor 401 functions as an acquisition unit that acquires the transaction data showing remaining points by acquiring the transaction.

In ACT20, the processor 401 determines the usable points. It should be noted that in a case of using the points in the points system 1, points corresponding to a value calculated in accordance with a certain calculation expression determined on the basis of the points issue source and the points use destination are usable. For example, it is assumed that in a case of using points of Pa [points] issued by a trader Sa in a trader Sb, points of Pb [points] are usable. At this time, Pb can be determined on the basis of a function f(Pa) of Pa. The function f is as in Expression (1) below, for example. It should be noted that Pb [points] will be sometimes referred to as “usable points”.

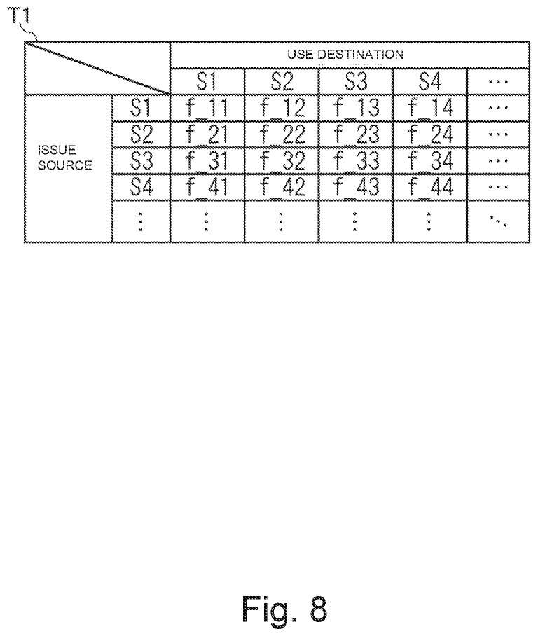

Pb=f(Pa)=α*Pa−β (1)

Where α is a coefficient determined on the basis of a combination of the points issue source and the points use destination. Further, β is a number determined on the basis of the combination of the points issue source and the points use destination. It should be noted that β is typically 0. The function f is defined by a table T1 as shown in FIG. 8, for example. FIG. 8 is a diagram showing an example of the table T1 stored in the auxiliary storage device 504. The table T1 indicates that the function f is the function f_31 in a case where the issue source is the trader S3 and the use destination is the trader S1, for example. The function f_31 is f_31(Pa)=α_31*Pa−β_31, for example. That is, in a case where the issue source is the trader S3 and the use destination is the trader S1, the value of α is α_31 and the value of β is β_31. It should be noted that the function f is determined on the basis of the points use destination or the like, for example. The processor 401 determines the usable points by referring to the table T1 in accordance with Expression (1) for each issue source. Here, the points use destination is a trader that installs the POS terminals 400, for example. The processor 401 functions as a processing unit that determines points usable at the points use destination by determining the usable points with the function f.

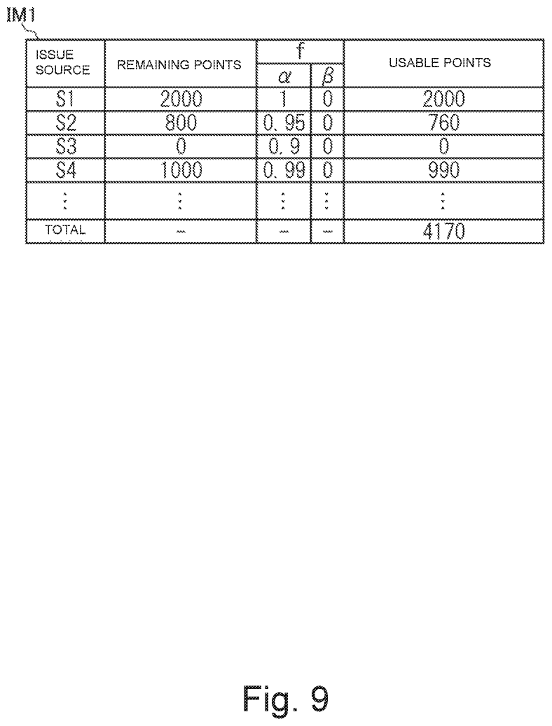

In ACT21, the processor 401 informs the operator of the POS terminal 400 and the shopping client of the usable points determined in ACT20. For example, the processor 401 causes the display device 408 to display an image IM1 as shown in FIG. 9. FIG. 9 is a diagram showing an example of the image IM1 displayed by the display device 408. It should be noted that a part of the image IM1 is omitted from FIG. 9. The image IM1 is a table indicating the remaining points, the function f, and the usable points for each points issue source, as shown in FIG. 9, for example. It should be noted that the image IM1 shows, for example, the function f with the value of α and the value of β. The image IM1 indicates that the remaining points whose issue source is the trader S2 is 800 [points] or the like, for example. Further, the image IM1 indicates that the usable points of the points whose issue source is the trader S2, for example, are 800 [points], which are 760 [points] obtained by multiplying the usable points by the coefficient 0.95, or the like. Further, the image IM1 indicates that the total usable points of all the issue sources is 4170 [points]. It should be noted that it is assumed that the total usable points of all the issue sources are the following “maximum points”. It should be noted that the processor 401 may inform of the remaining points, the usable points, and the function f of each issue source in accordance with another method. For example, the processor 401 performs voice informing. The processing of processor 401 returns to ACT12 after the processing of ACT21.

In a case where the processor 401 determines in ACT15 that the complete operation has been performed under the standby state of ACT12 to ACT15 (Yes in ACT15), the processing of the processor 401 proceeds to ACT22. In ACT22, the processor 401 determines whether or not points to be used in settlement (hereinafter, referred to as “use points”) has been input by the input device 409, for example. It should be noted that the use points need to be equal to or smaller than maximum points and equal to or smaller than a total amount of commodities and services registered in the commodity list. It should be noted that a total amount includes a tax, a service charge, and the like. In a case where the processor 401 determines that the use points have not been input (No in ACT22), the processing of the processor 401 proceeds to ACT23.

In ACT23, the processor 401 determines whether or not to start settlement processing. The processor 401 determines to start the settlement processing in response to operation on the button of the input device 409 for instructing to start the settlement processing, for example.

In a case where the processor 401 determines not to start the settlement processing (No in ACT23), the processing of the processor 401 returns to ACT22. In this manner, the processor 401 repeats the processing of ACT22 and ACT23 until the processor 401 determines that the use points have been input (Yes in ACT22) or determines to start the settlement processing (Yes in ACT23).

In a case where the processor 401 determines in ACT22 that the use points have been input under the standby state of ACT22 and ACT23 (Yes in ACT22), the processing of the processor 401 proceeds to ACT24.

In ACT24, the processor 401 calculates the remaining amount obtained by subtracting the use points from the total amount. Then, the processor 401 informs of the remaining amount. For example, the processor 401 causes the display device 408 to display the remaining amount. The processing of processor 401 proceeds to ACT23 after the processing of ACT24.

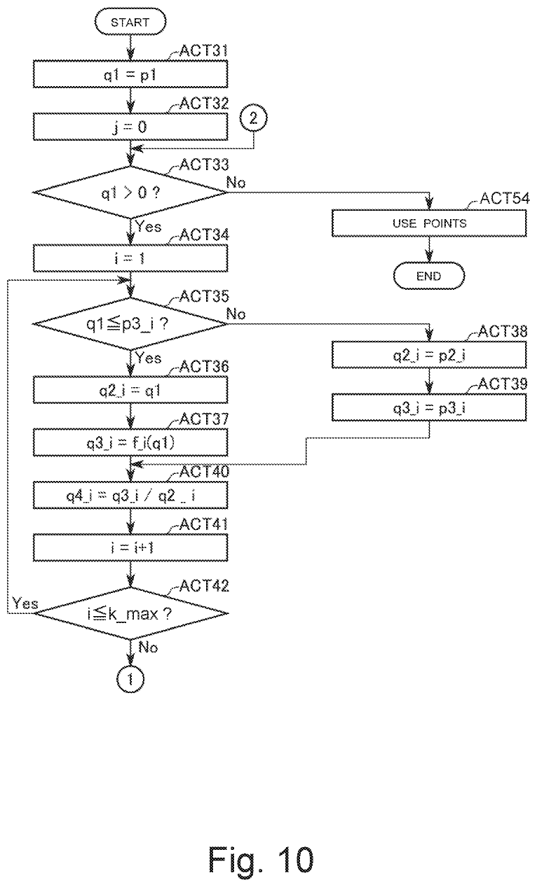

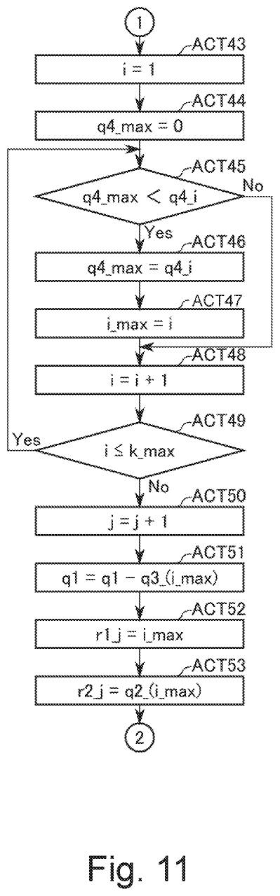

In a case where the processor 401 determines in ACT23 to start the settlement processing under the standby state of ACT22 and ACT23 (Yes in ACT23), the processing of the processor 401 proceeds to ACT25. In ACT25, the processor 401 performs the settlement processing. It should be noted that regarding settlement by payment other than points of the cash, the credit card, and the like, the description will be omitted because a well-known method can be used. Here, only the settlement using the points will be described with reference to FIGS. 10 and 11. FIGS. 10 and 11 are flowcharts each showing an example of the processing of the processor 401 of the POS terminal 400. The processor 401 executes this processing on the basis of the program stored in the ROM 402 or the auxiliary storage device 404 or the like, for example. It should be noted that the processor 501 assigns each variable to the RAM 503 or the like when starting the processing shown in FIGS. 10 and 11 or the like, for example.

In ACT31 of FIG. 10, the processor 401 substitutes a value p1 for a variable q1. It should be noted that the value p1 indicates the use points. The variable q1 indicates points of the use points, the issue source of which is undetermined.

In ACT32, the processor 401 substitutes 0 for the variable j. The variable j is a counter.

In ACT33, the processor 401 determines whether or not the value of the variable q1 exceeds 0. In a case where the processor 401 determines that the value of the variable q1 exceeds 0 (Yes in ACT33), the processing of the processor 401 proceeds to ACT34. In ACT34, the processor 401 substitutes 1 for a variable i. The variable i is a counter.

In ACT35, the processor 401 determines whether or not the value of the variable q1 is equal to or smaller than the value p3_i. It is assumed that the usable points whose issue source are the trader S1 is p3_1 and the usable points whose issue source is the trader S2 are p3_2, . . . Generalizing them, a value p3_k indicates usable points whose issue source is a trader Sk. It should be noted that k is an integer which is equal to or larger than 1 and equal to or smaller than k_max. Where k_max is a total number of issue sources. In a case where the processor 401 determines that the value of the variable q1 is equal to or smaller than the value p3_i (Yes in ACT35), the processing of the processor 401 proceeds to ACT36.

In ACT36, the processor 401 substitutes the value of the variable q1 for a variable q2_i. It should be noted that the variable q2_i indicates points to be used in a case where the issue source uses points of a trader Si. In ACT37, the processor 401 substitutes a calculation result of f_i(q1) for a variable q3_i. It should be noted that f_i is a function f about the points whose issue source is the trader Si. For example, f_i(q1)=(α_i*q1−β_i) is established. It should be noted that α_i is a value of a about the points whose issue source is the trader Si. Further, β_i is a value of β about the points whose issue source is the trader Si. It should be noted that the variable q3_i indicates usable points in a case of using q2_i [points] of the points whose issue source is the trader Si.

On the other hand, in a case where the processor 401 determines that the value of the variable q1 exceeds the value p3_i (No in ACT35), the processing of the processor 401 proceeds to ACT38. In ACT38, the processor 401 substitutes a value p2_i for the variable q2_i. It is assumed that remaining points whose issue source is the trader S1 are p2_1 and the remaining points whose issue source is the trader S2 are p2_2, . . .

Generalizing them, remaining points whose issue source is the trader Sk is p2_k. In ACT39, the processor 401 substitutes the value p3_i for the variable q3_i.

The processing of processor 401 proceeds to ACT40 after the processing of ACT37 or ACT39. In ACT40, the processor 401 substitutes a calculation result of (q3_i/q2_i) for a variable q4_i. It should be noted that the variable q4_i indicates what times of q2_i [points] usable points in a case of using q2_i [points] of the points whose issue source is the trader Si are. In ACT41, the processor 401 increments the value of the variable i by 1.

In ACT42, the processor 401 determines whether or not the value of the variable i is equal to or smaller than the value k_max. In a case where the processor 401 determines that the value of the variable i is equal to or smaller than the value k_max (Yes in ACT42), the processing of the processor 401 returns to ACT35. On the other hand, in a case where the processor 401 determines that the value of the variable i exceeds a value k_max (No in ACT42), the processing of the processor 401 proceeds to ACT43 of FIG. 11.

In ACT43, the processor 401 substitutes 1 for the variable i. In ACT44, the processor 401 substitutes 0 for a variable q4_max.

In ACT45, the processor 401 determines whether or not the value of the variable q4_max is smaller than the value of the variable q4_i. In a case where the processor 401 determines that the value of the variable q4_max is smaller than the value of the variable q4_i (Yes in ACT45), the processing of the processor 401 proceeds to ACT46. In ACT46, the processor 401 substitutes the value of the variable q4_i for the variable q4_max. In ACT47, the processor 401 substitutes the value of the variable i for a variable i_max.

On the other hand, in a case where the processor 401 determines that the value of the variable q4_max is equal to or larger than the value of the variable q4_i (No in ACT45), the processing of the processor 401 proceeds to ACT48. Further, the processing of the processor 401 proceeds to ACT48 also after the processing of ACT47.

In ACT48, the processor 401 increments the value of the variable i by 1. In ACT49, the processor 401 determines whether or not the value of the variable i is equal to or smaller than the value k_max. In a case where the processor 401 determines that the value of the variable i is equal to or smaller than the value k_max (Yes in ACT49), the processing of the processor 401 returns to ACT45. On the other hand, in a case where the processor 401 determines that the value of the variable i exceeds the value k_max (No in ACT49), the processing of the processor 401 proceeds to ACT50. The processor 401 repeats the processing of ACT45 to ACT49 as described above, to thereby determine an issue source from which the points should be used for minimizing the points to be used. In a case where the processor 401 determines that the value of the variable i exceeds the value k_max (No in ACT49), the value of the variable q4_max is a maximum value of q4_i in a range of 1≤i≤k_max. Further, in a case where the processor 401 determines that the value of the variable i exceeds the value k_max (No in ACT49), the variable i_max indicates that the points to be used are minimum in a case of using points whose issue source is the trader Si_max.

In ACT50, the processor 401 increments the value of the variable j by 1. In ACT51, the processor 401 substitutes a calculation result of (q1−q3_(i_max)) for the variable q1. In ACT52, the processor 401 substitutes a value of the variable i_max for a variable r1_j. It should be noted that the variable r1_j indicates an issue source from which the points should be used. In ACT53, the processor 401 substitutes a value of the variable q2_(i_max) for a variable r2_j. It should be noted that the variable r2_j indicates that the issue source uses r2_j [points] of points of a trader Sr1_j. The processor 401 returns to ACT33 of FIG. 10 after the processing of ACT53.

In a case where the processor 401 determines that the value of the variable q1 is equal to or smaller than 0 (No in ACT33), the processing of the processor 401 proceeds to ACT54. In ACT54, the processor 401 performs processing for using r2_1 [points] of the points whose issue source is the trader Sr1_1, r2_2 [points] of the points whose issue source is the trader Sr1_2, . . . , and r2_j [points] of the points whose issue source is the trader Sr1_j from the target points account. For example, the processor 401 posts each of a transaction in which the points whose issue source is a trader Sr1_1 are subtracted by r2_1 [points] from the target points account, a transaction in which the points whose issue source is a trader Sr1_2 by r2_2 [points] from the target points account, . . . , and a transaction in which points whose issue source is a trader Sr1_j-1 is subtracted by r2_j [points] from the target points account, to the distributed ledger DL1. Correspondingly, the distributed ledger DL1 agrees with and authorizes the posted transactions. Accordingly, those transactions are recorded in the distributed ledger DL1. It should be noted that post of the transaction may be directly performed by the POS terminals 400 or may be performed by the headquarter server 200 or the store server 300 on the basis of the information sent from the POS terminal 400. The processor 401 terminates the processing shown in FIG. 11 of FIG. 10 after the processing of ACT54.

The description will be continued referring back to FIG. 7. In ACT26 of FIG. 7, the processor 401 determines whether or not the points ID is stored as the variable VP1. In a case where the processor 401 determines that the points ID is stored as the variable VP1 (Yes in ACT26), the processing of the processor 401 proceeds to ACT27.

In ACT27, the processor 401 gives points corresponding to a purchase amount to the target points account. For example, the processor 401 gives the points of Pc=γ×(total amount−use points) [points].

It should be noted that γ is a value equal to or smaller than 1, which varies depending on the issue source. For example, in a case where the POS terminal 400 is installed by the trader Sk, the processor 401 posts a transaction for incrementing the points whose issue source is the trader Sk by Pc [points] to the target points account in the distributed ledger DL1. It should be noted that post of the transaction may be directly performed by the POS terminal 400 as described above or may be the headquarter server 200 or the store server 300 on the basis of the information sent from the POS terminal 400.

The processing of processor 401 proceeds to ACT28 after the processing of ACT27. Further, in a case where the processor 401 determines that the points ID is not stored as the variable VP1 (No in ACT26), the processing of the processor 401 proceeds to ACT28. In ACT28, the processor 401 sends information regarding the transaction in which the settlement has been performed to the headquarter server 200 or the store server 300. Correspondingly, the headquarter server 200 or the store server 300 records the sent information regarding the transaction. It should be noted that in a case where it is the POS terminal 400 installed by the trader in which the store server 300 and the headquarter server 200 is not installed as in the trader S3, the processor 401 does not perform the processing of ACT28.

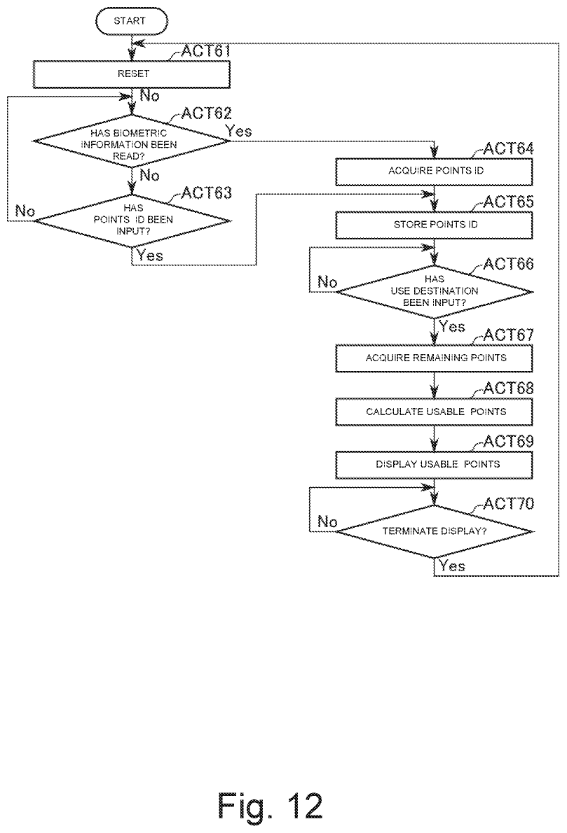

Next, processing of the client terminal 500 will be described with reference to FIG. 12. FIG. 12 is a flowchart showing an example of the processing of the processor 501 of the client terminal 500. The processor 501 executes this processing on the basis of the program stored in the ROM 502, the auxiliary storage device 504, or the like, for example. It should be noted that in a case where the processing of the processor 501 proceeds ACT(n+1) after processing of ACTn (n is a natural number), the description about this will be omitted in some cases.

In ACT61 of FIG. 12, the processor 501 of the client terminal 500 resets a variable VP2 to obtain a state in which the points ID has not been stored as the variable VP2.

In ACT62, the processor 501 determines whether or not the biometric information has been read through the biometric sensor 507. In a case where the processor 501 determines that the biometric information has not been read by the biometric sensor 507 (No in ACT62), the processing of the processor 501 proceeds to ACT63.

In ACT63, the processor 501 determines whether or not the points ID has been input. For example, when the reader/writer 506 or the scanner 509 reads the points ID from the points card, the points ID output by the reader/writer 506 or the scanner 509 is input into the processor 501. In a case where the processor 501 determines that the points ID has not been input (No in ACT63), the processing of the processor 501 returns to ACT62. In this manner, the processing of the processor 501 repeats ACT62 and ACT63 until the processor 501 determines that the biometric information has been read through the biometric sensor 507 (Yes in ACT62) or the processor 501 determines that the points ID has been input (Yes in ACT63).

In a case where the processor 501 determines in ACT62 that the biometric information has been read through the biometric sensor 507 under the standby state of ACT62 and ACT63 (Yes in ACT62), the processing of the processor 501 proceeds to ACT64.

In ACT64, the processor 501 acquires a points ID by referring to a biometric information database in which pieces of biometric information are associated with points IDs on the basis of the biometric information read in ACT62. It should be noted that the biometric information database is stored in the auxiliary storage device 204 of the headquarter server 200, the auxiliary storage device 304 of the store server 300, the auxiliary storage device 404 of the POS terminal 400, the client terminal 500, or a server common between the plurality of traders, the distributed ledger DL1, a P2P distributed storage, or the like, for example. The processor 501 acquires the biometric information database from any one of the above-mentioned locations and refers to the acquired biometric information database.

In a case where the processor 501 determines in ACT63 that the points ID has been input under the standby state of ACT62 and ACT63 (Yes in ACT63), the processing of the processor 501 proceeds to ACT65. In ACT65, the processor 501 stores the points ID acquired in ACT64 or the points ID input in ACT63. That is, the processor 501 substitutes the points ID acquired in ACT64 or the points ID input in ACT63 for the variable VP2. It should be noted that the points ID stored as the variable VP2 will be referred to as a “target points ID” hereinafter.

In ACT66, the processor 501 stands by until the points use destination is input. The operator of the client terminal 500 selects one of the trader S1 to the trader Sk_max as the points use destination and inputs the selected one, for example. In a case where the processor 501 determines that the points use destination has been input (Yes in ACT66), the processing of the processor 501 proceeds to ACT67.

In ACT67, the processor 501 acquires the remaining points of the target points account. It should be noted that the processor 501 acquires the remaining points as in ACT19, for example. In ACT68, the processor 501 determines the usable points as in ACT20.

In ACT69, the processor 501 informs the operator of the client terminal 500 of the usable points determined in ACT68. For example, the processor 501 causes the touch panel 508 to display the image IM1 as shown in FIG. 9. Alternatively, the processor 501 may inform of the remaining points, the usable points, and the function f of each issue source in accordance with another method. For example, the processor 501 performs voice informing. In ACT70, the processor 501 determines whether or not the operation to terminate the display has been performed. In a case where the processor 501 determines that the operation to terminate is not performed (No in ACT15), the processing of the processor 501 enters the standby state. In a case where the processor 501 determines that the operation to terminate has been performed (Yes in ACT15), the processing of the processor 401 ends.

The points system 1 according to the embodiment manages points by using the distributed ledger DL1. Therefore, the cost for points management can be made lower than that according to the conventional method without the distributed ledger. Further, the points system 1 according to the embodiment has higher security and fault-tolerance than those in the case of not using the distributed ledger.

With the points system 1 according to the embodiment, the POS terminal 400 determines usable points on the basis of the function f (see FIG. 9) determined on the basis of the combination of the points issue source and the points use destination. In this manner, the points system 1 according to the embodiment performs calculation necessary for sharing points outside the distributed ledger DL1, and thus the burden on the distributed ledger DL1 can be reduced. Further, the points system 1 according to the embodiment performs calculation necessary for sharing points outside the distributed ledger DL1, and thus an increase in amount of data of transactions on the distributed ledger DL1 can be reduced.

Further, with the points system 1 according to the embodiment, the POS terminals 400 displays the remaining points, the usable points, and the function f of each issue source with respect to the target points account on the display device 408 (see FIG. 9). Accordingly, the operator of the POS terminal 400 and the shopping client can know the remaining points, the usable points, and the function f of each issue source with respect to the target points account at the time of accounting. Further, with the points system 1 according to the embodiment, the client terminal 500 displays the remaining points, the usable points, and the function f of each issue source with respect to the target points account on the touch panel 508 (see FIG. 9). Accordingly, the shopping client or the like can know the remaining points, the usable points, and the function f of each issue source with respect to the target points account at a time other than the time of accounting, for example, when the shopping client or the like is outside the store.

With the points system 1 according to the embodiment, the POS terminal 400 determines usable points on the basis of the coefficient α (see FIG. 9) determined on the basis of the combination of the points issue source and the points use destination. Therefore, α in a case where the points issue source and the points use destination are different, for example, is set to be a value smaller than 1. Accordingly, the usable points in a case where the points issue source and the points use destination are different can be made smaller than the usable points in a case where the points issue source and the points use destination are the same.

The following modification of the above-mentioned embodiment may be made. The headquarter server 200 or the store server 300 may perform some of the processes performed by the POS terminal 400 in the above-mentioned embodiment. In this case, the POS terminal 400, the headquarter server 200, and the store server 300 operate as the points management apparatus in cooperation. Alternatively, the headquarter server 200 or the store server 300 operates as the points management apparatus. The headquarter server 200 or the store server 300 may perform some of the processes performed by the client terminal 500 in the above-mentioned embodiment. In this case, the client terminal 500 and the headquarter server 200 or the client terminal 500 and the store server 300 operate as the points management apparatus in cooperation. Alternatively, the headquarter server 200 or the store server 300 operates as the points management apparatus.

In the above-mentioned embodiment, the points issue source is each trader. However, the points issue source may be each store. Alternatively, the plurality of traders or stores may be a common issue source.

In the above-mentioned embodiment, the POS terminal 400 automatically determines an issue source from which the points should be used in a manner that depends on the use points. However, the POS terminal 400 may be capable of separately inputting an issue source from which the points are to be used and how much points are to be used. In this case, the POS terminal 400 performs settlement using points in a manner that depends on that input.

In the above-mentioned embodiment, the trader having the actual store has been shown as an example. However, the trader may be a trader which has no stores and sells commodities or services by mail, for example. In this case, in the above-mentioned embodiment, the processing performed by the POS terminal 400 performs the headquarter server 200 or the like, for example.

The points managed by the points system 1 may be points that can be purchased using the legal tender or the like. That is, the points managed by the points system 1 may be prepaid-type electronic money. In addition, the points system 1 is capable of managing various other points. Further, the points managed by the points system 1 are not limited to the corporate currency and may be local money or the like.

The headquarter server 200 also serves as the node 100. The store server 300 also serves as the node 100.

The remaining points may be recorded in a state database (DB) or the like as shown in Hyperledger fabric. The state DB records a transaction or the like of the latest state after the transaction is executed. In this case, the POS terminal 400 may acquire the remaining points from the state DB. Each of the headquarter server 200, the store server 300, the POS terminal 400, the client terminal 500, and the like does not need to calculate the remaining points on the basis of the transaction by acquiring the remaining points from the state DB. Accordingly, each of the above-mentioned apparatuses can perform the processing in a shorter time. It should be noted that the processor 401 functions as an acquisition unit that acquires the transaction data showing remaining points by acquiring the remaining points from the state DB.

The processor 101, the processor 201, the processor 301, the processor 401, or the processor 501 may realize some or all of the processes to be realized by the program in accordance with the hardware configuration of the circuit in the above-mentioned embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A points management method for commonly managing points by using a distributed ledger, the points being issued to a customer in a manner that depends on purchase of a commodity or use of a service from a plurality of different points issue sources and being usable by the customer for at least a part of a price of purchase of a commodity or use of a service at a plurality of points use destinations, the method comprising:
recording, in the distributed ledger, transaction data showing remaining points retained in a points account of each customer, the points account being used as a wallet;
determining a points account of a customer by using an identification code uniquely given to each points account;
determining remaining points retained in the determined points account on a basis of the transaction data; and
determining points of the determined remaining points on a basis of a function determined on a basis of a combination of one of the plurality of different points issue sources and one of the plurality of points use destinations, the points being usable at the one of the plurality of points use destinations.

2. The points management method according to claim 1, further comprising
pre-storing, in a storage device, functions determined on a basis of combinations of the plurality of different points issue sources and the plurality of points use destinations.

3. The points management method according to claim 1, wherein
determining remaining points includes determining remaining points for each of the plurality of different points issue sources.

4. The points management method according to claim 1, further comprising
subtracting points issued by one of the plurality of different points issue sources from the remaining points of the points account and settling an amount corresponding to points of the reduced points at the one of the plurality of points use destinations, the points being determined on a basis of the function.

5. The points management method according to claim 1, further comprising
informing of the determined points usable at the one of the plurality of points use destinations.

6. The points management method according to claim 5, wherein
informing of the determined usable points includes displaying, for each of the plurality of different points issue sources, the remaining points and the usable points of the remaining points.

7. The points management method according to claim 5, wherein
the function comprises the remaining points multiplied by a predetermined coefficient.

8. The points management method according to claim 7, wherein
informing of the usable points includes displaying the predetermined coefficient of the function for each of the plurality of different points issue sources.

9. A points management apparatus for commonly managing points by using a distributed ledger, the points being issued to a customer in a manner that depends on purchase of a commodity or use of a service from a plurality of different points issue sources and being usable by the customer for at least a part of a price of purchase of a commodity or use of a service at a plurality of points use destinations, the apparatus comprising:
a communication interface for communication by using a distributed ledger in which transaction data showing remaining points retained in a points account of each customer is recorded, the communication being performed via a network;
an acquisition device that acquires an identification code given to a points account of each customer in the distributed ledger, the points account being to be used as a wallet;
a storage device that pre-stores, in a storage device, functions for determining points usable at the plurality of points use destinations, the functions being determined on a basis of combinations of the plurality of different points issue sources and the plurality of points use destinations; and
a processor that
determines a points account of a customer by using the identification code acquired by the acquisition device,
extracts the transaction data associated with the determined points account from the distributed ledger via the communication interface and determines remaining points of the determined points account on a basis of the extracted transaction data, the remaining points being issued from the plurality of different points issue sources, and
determines points of the determined remaining points for each of the plurality of different points issue sources on a basis of one of the functions pre-stored in the storage device, the points being usable at one of the points use destination.

10. The points management apparatus according to claim 9, further comprising
a display device that displays the determined remaining points and the determined usable points, wherein
the functions each comprises the remaining points multiplied by a predetermined coefficient, and
the processor causes the display device to display the predetermined coefficient of the function as well as the determined remaining points and the determined usable points for each of the plurality of different points issue sources.
